(19) United States
(12) Patent Application Publication
(10) Pub. No.: US 2016/0330810 A1
(43) Pub. Date: Nov. 10, 2016

(54) DEVICE FOR DISTRIBUTING ELECTRICAL POWER IN A LUMINAIRE

(71) Applicant: Tech Lighting LLC, Skokie, IL (US)

(72) Inventors: Doug Hamilton, Arlington Heights, IL (US); Bruce Rhodes, Inverness, IL (US); Anthony Mackey, Downers Grove, IL (US); Kevin Michael Fagan, Oak Park, IL (US); David Kaplan, Chicago, IL (US)

(21) Appl. No.: 14/945,668

(22) Filed: Nov. 19, 2015

Related U.S. Application Data
(60) Provisional application No. 62/156,704, filed on May 4, 2015.

(51) Int. Cl. H05B 33/08

(52) U.S. Cl. CPC H05B 33/0842

(57) ABSTRACT

A luminaire with a plurality of light-producing subsystems includes a single-channel driver to electrically power each of the plurality of the light-producing subsystems and a distribution device that receives electrical power from the single-channel driver and that distributes the electrical power to the plurality of light-producing subsystems. The distribution device is preferably responsive to controllable distribution settings, such that the amount of power distributed to each light emitting subsystem may be selectively varied and controlled in response to control input. A method of providing a desired output of light from a luminaire including such a distribution device is also provided.

This application claims the benefit of provisional U.S. Patent Application No. 62/156,704, the entirety of which is incorporated herein by reference.

### FIELD

This application generally relates to luminaires, and, more particularly, to a luminaire having a device for distributing electrical power to different light-producing sub systems in the luminaire.

### BACKGROUND

A luminaire is generally understood to include one or more light producing subsystems carried by a housing along with power and driving and/or power distribution devices. In this manner, the luminaire provides a single unit that is easy to install and/or ship. An example of a luminaire is a light fixture, such as a hanging light fixture commonly installed to hang from a ceiling or wall. However, there are many different types of luminaires and the luminaire discussed herein may include all such devices.

Many commercial buildings (e.g., retail stores), office buildings, parking structures, and the like are equipped with lighting systems that typically include several luminaires (e.g., light fixtures) configured to illuminate certain areas. Some of these luminaires include two or more light-emitting components, for example two or more light-emitting diode boards. In some cases, the different light-emitting components are powered by separate drivers, with each of the drivers being independently controlled. In other cases, the different light-emitting components are powered by two (or more) channel drivers, with each of the channels being independently controlled.

The independent control of each light-emitting component provided by both of these known arrangements advantageously allows the different light-emitting components to be independently controlled to yield a desired output of light from the luminaires. At the same time, however, utilizing separate drivers for each light-emitting component and multi-channel drivers is neither cost-effective nor energy-efficient. Indeed, some multi-channel drivers do not comply with many of the more progressive energy codes and regulations that have recently been, or may in the future be, adopted by states (e.g., California), the federal government, and local municipalities. As an example, a two-channel driver constructed to supply 40 Watts of electrical power to one light-emitting component (via the first channel) and 40 Watts of electrical power to another light-emitting component (via the second channel) will be rated as an 80 Watt driver, meaning that the driver would not be compliant with an energy code such as California's (e.g., Title 24) that places strict limits on energy output, despite the fact that the driver only provides 40 Watts to each light-emitting component.

### SUMMARY

According to some aspects, a luminaire with a plurality of light-producing subsystems includes a single-channel driver to electrically power each of the plurality of the light-producing subsystems and a distribution device that receives electrical power from the single-channel driver and that distributes the electrical power to the plurality of light-producing subsystems. The distribution device is preferably responsive to controllable distribution settings, such that the amount of power distributed to each light emitting subsystem may be selectively varied and controlled in response to control input.

In some aspects, a method of providing a desired output of light from a luminaire including such a distribution device is provided.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a block diagram of a luminaire constructed in accordance with the teachings of the present disclosure.

FIG. 2 is a block diagram of one example of a distribution device that can be utilized in the luminaire of FIG. 1.

FIG. 3 illustrates another example of a distribution device that can be utilized in the luminaire of FIG. 1.

### DETAILED DESCRIPTION

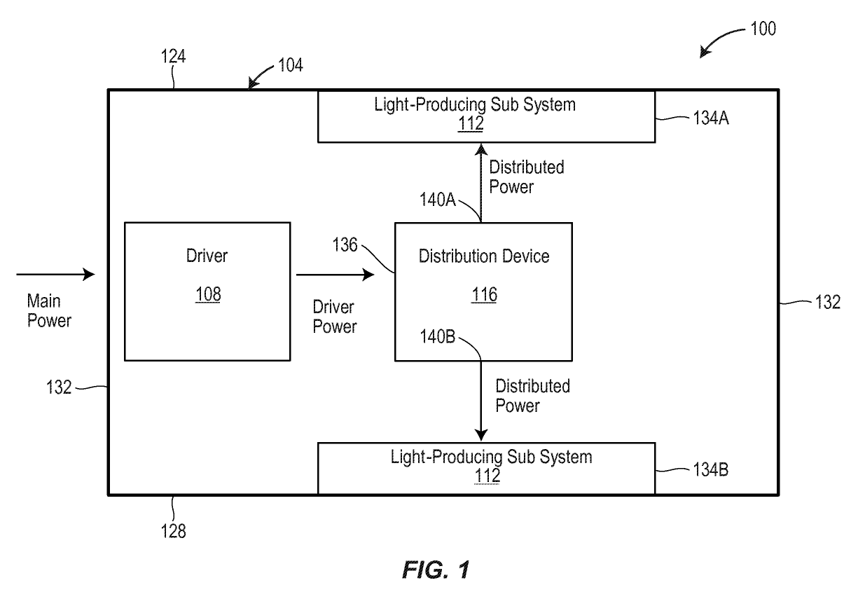

FIG. 1 illustrates one example of a luminaire 100 constructed in accordance with the present disclosure. The luminaire 100 is associated with a lighting system or a portion thereof, such as, for example, a lighting system included or employed in a parking garage (or a floor or section of the parking garage), commercial building (or a portion thereof), roadway, tunnel, or other structure (or a portion thereof), office building, residential home or building, or other indoor or outdoor space or environment. The luminaire 100 can be suspended from a structure (e.g., a ceiling, wall) in the indoor or outdoor space or environment, attached to or installed within the structure, or otherwise mounted to or in the desired structure. In some examples, the lighting system can include a plurality of luminaires 100. For example, a plurality of luminaires 100 can be arranged in an end-to-end series or in a matrix-type configuration, where needed.

The luminaire 100 illustrated in FIG. 1 includes a housing 104, a single-channel driver 108 carried by and/or disposed within the housing 104, and two light-producing sub systems 112 carried by and/or disposed (e.g., installed) within the housing 104 and powered by the single-channel driver 108. The luminaire 100 also includes a distribution device 116 that is electrically connected to and between the driver 108 and the two light-producing sub systems 112. The distribution device 116 is configured to distribute the electrical power supplied or provided by the driver 108 to the two light-producing sub systems 112. This distribution of power is performed based on distribution settings, with those distribution settings being controllable such that light having different characteristics (e.g., efficiencies, color temperatures, colors, directions, intensities, etc.) can be output from the luminaire 100, as desired. The distribution device 116 is preferably carried by and/or disposed within the housing 104.

While the luminaire 100 is described as including one single-channel driver 108, it will be appreciated that in other examples, the luminaire 100 can include multiple single-channel drivers 108. Additionally, while the luminaire 100 is described as including two light-producing sub systems 112, the luminaire 100 can, in other examples, include more than two light-producing sub systems 112. As an example, the luminaire 100 can include three, four, five, or any other number of light-producing sub systems 112. Any additional light-producing sub systems 112 can be powered by the single-channel driver 108 or by additional single-channel drivers 108. Further yet, while the luminaire 100 illustrated in FIG. 1 includes only one distribution device 116, in other examples the luminaire 100 can include multiple distribution devices 116, such as, for example, when the luminaire 100 includes more than two light-producing sub systems 112.

The housing 104 can be made of aluminum, stainless steel (e.g., 316 Stainless Steel), other metals, plastic, or combinations thereof. In one exemplary arrangement, the housing 104 has a substantially rectangular shape defined by a top wall 124, a bottom wall 128, and four sidewalls 132 (only 2 of which are visible in FIG. 1) coupled to and extending between the top and bottom walls 124, 128. The housing 104 also includes a rectangularly-shaped opening 134A formed or defined in the top wall 124 and a rectangularly-shaped opening 134B formed or defined in the bottom wall 128. Each opening 134A, 134B is generally sized to receive one of the light-producing sub systems 112, as will be described in greater detail below.

In other examples, the housing 104 can have a different size and/or shape. As an example, the housing 104 can have a triangular shape, a cylindrical shape, an irregular shape, or some other shape. In the event that the housing 104 has a different shape, the housing 104 will necessarily be defined differently. When, for example, the housing 104 has a cylindrical shape, the housing 104 may be defined by a top wall, a bottom wall, and only one circumferential sidewall. In some examples, the openings 134A, 134B can vary in shape and/or size, and/or the housing 104 need not include the openings 134A, 134B. As an example, the light-producing sub systems 112 can be arranged outside of the interior of the housing 104.

The single-channel driver 108 can be secured within the housing 104 in any known manner. The single-channel driver 108 in this example is a single-channel LED driver that includes various components configured to supply electric power from a main power source, such as a standard AC or a DC electrical power source (not shown), to the lighting boards 108. The single-channel driver 108 preferably can output electric power in a range of 10-150 Watts, depending on the desired location and usage of the luminaire 100. Of course, in other examples, the single-channel driver 108 need not be an LED driver and can instead be configured to supply power to different types of light-producing sub systems 112.

The two light-producing sub systems 112 are formed or arranged in the top and bottom walls 124, 128, respectively, of the housing 104. As such, the light-producing sub systems 112 provide directional lighting by emitting light in two different directions, in this case from the top of the luminaire 100 and from the bottom of the luminaire 100, generally perpendicular to the outwardly facing surface of the luminaire 100.

The light-producing sub systems 112 in this example take the form of light-emitting diode (LED) boards. The LED boards can include any number of LEDs. The LEDs on these boards emit white light having a color temperature ranging from 2700K to 4000K. Each LED can emit up to 135 lumens of light. In total, each LED board can emit up to approximately 15,000 lumens of light.

In other examples, one or both of the light-producing sub systems 112 can be arranged in a different portion of the luminaire housing 104 (e.g., in one of the sidewalls 132), coupled to an exterior portion of the luminaire housing 104 (i.e., not arranged within an interior of the housing 104), and/or arranged in some other manner relative to the housing 104, such that the light-producing sub systems 112 can provide different directional lighting (e.g., lighting in different directions) than the sub systems 112 described herein. In other examples, one or both of the light-producing sub systems 112 need not take the form of LED boards. Instead, one or both light-producing systems 112 can include one or more LEDs (e.g., not arranged on a board), fluorescent lights, incandescent lights, plasma lights, and/or other types of electrically powered light-emitting components. Further yet, the light-producing sub systems 112 can emit or provide light having different characteristics. For example, the light-producing sub systems 112 may provide light having different colors, color temperatures, color rendering indices, efficiencies, intensities, and/or other characteristics. As an example, in one arrangement, one of the light-producing sub systems 112 emits white light, while another one of the light-producing sub systems 112 emits yellow light.

With reference still to FIG. 1, the distribution device 116 is electrically connected to and between the single-channel driver 108 and the light-producing sub systems 112. In this example, the distribution device 116 has a power input port 136 and two power output ports 140A, 140B. The single-channel driver 108 provides electrical power to the distribution device 116 via the input port 136. In turn, the distribution device 116 distributes received electrical power to the light-producing sub systems 112 via the output ports 140A, 140B. In other examples, the distribution device 116 can include additional power input ports 136 (e.g., when multiple single-channel drivers 108 are utilized) and/or additional power output ports 140A, 140B (e.g., when additional light-producing sub systems 112 are utilized).

As briefly discussed above, power distribution by the distribution device 116 is based on controllable distribution settings indicative of how the electrical power is to be distributed to or between the light-producing sub systems 112 via conductors from the output ports 140A, 140B. The distribution settings may indicate that the power provided by the driver 108 is to be equally distributed to each of the light-producing sub systems 112. Alternatively, the distribution settings may indicate that the power provided by the driver 108 is to be unevenly distributed to or amongst light-producing sub systems 112. As an example, the distribution settings may indicate that 40% of the power is to be provided to the light-producing sub system 112 arranged in the top 124 of the luminaire 100, while 60% of the power is to be provided to light-producing sub system 112 arranged in the bottom 128 of the luminaire 100. Of course, if desired, the distribution settings may indicate that power is not to be distributed to one of the light-producing sub systems 112. From this, it is evident that power distribution is such that power received from the driver is partitioned into different portions, one portion for each light-producing subsystem, wherein each portion is provided to the respective light-producing subsystem.

In some cases, initial distribution settings can be pre-programmed, during manufacturing or during installation of the luminaire 100, into the distribution device 116. As an example, the distribution device 116 can be pre-programmed to equally distribute the electrical power provided by the driver 108. These initial distribution settings, as well as any further distribution settings, can be controlled (e.g., adjusted) to facilitate control of (e.g., changes to) the luminaire 100. More specifically, distribution settings can be controlled such that the first and second light-producing sub systems 112 can output light having different characteristics (e.g., efficiencies, color temperatures, colors, directions, intensities, etc.), as desired. The distribution settings can, in this example, be controlled to increase or decrease the amount of light emitted by the first and/or second light-producing sub systems 112 (i.e., increase or decrease the amount of upward and/or downward lighting provided by the luminaire 100). The distribution settings can, in other examples, be controlled to increase or decrease the amount of high and/or low efficiency lighting, increase or decrease the emission of light of one or more colors, increase or decrease the emission of light of one or more color temperatures, etc.

The distribution device 116, and more particularly the distribution settings, can be controlled in a number of different manners. In some examples, the distribution settings can be controlled via an on-board device (e.g., an on-board controller, an on-board selector switch) carried by and/or arranged within the luminaire 100. In other examples, the distribution settings can be controlled by a control signal received, at the distribution device 116, from an external device (e.g., an external controller, a mobile device, etc.) communicatively coupled to the distribution device 116. In one example, the control signal may be a 0-10 V lighting control signal. Responsive to such a control signal, the distribution device 116 may, at 10V, distribute 100% of the electrical power provided by the driver 108 to one of the first and second light-producing sub systems 112 (and distribute 0% to the other light-producing sub system 112), and may, at 5 V, equally distribute the electrical power provided by the driver 108 to each of the first and second light-producing sub systems 112. In another example, the control signal may be a DALI, DMX, or other suitable protocol-based control signal. In other examples, the control signal may take the form of or include a power distribution ratio (e.g., 50/50, 60/40, 70/30, 40/60, 30/70), discrete power numbers (e.g., 10 W to the first light-producing sub system 112), binary numbers (e.g., 1 being indicative of an instruction to turn on the first light-producing sub system 112), some other quantity, or even quantitative instructions.

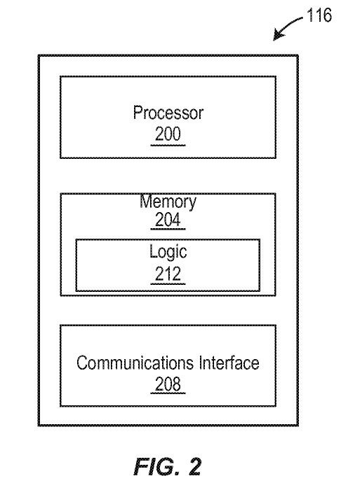

FIG. 2 illustrates a block diagram of one example of the distribution device 116. The distribution device 116 illustrated in FIG. 2 generally includes a processor 200, a memory 204, a communications interface 208, and computing logic 212.

The processor 200 may be a general processor, a digital signal processor, ASIC, field programmable gate array, graphics processing unit, analog circuit, digital circuit, or any other known or later developed processor. The processor 200 operates pursuant to instructions in the memory 204. More specifically, the processor 200 operates pursuant to distribution instructions stored in the memory 204. At least initially, the processor 200 can operate pursuant to pre-programmed or pre-selected distribution settings (i.e., distribution settings set prior to the installation or operation of the luminaire 100). Over time, these distribution settings can be controlled (e.g., altered or adjusted) as discussed below.

The memory 204 may be a volatile memory or a non-volatile memory. The memory 204 may include one or more of a read-only memory (ROM), random-access memory (RAM), a flash memory, an electronic erasable program read-only memory (EEPROM), or other type of memory. The memory 204 may include an optical, magnetic (hard drive), or any other form of data storage device.

The communications interface 208, which may be, for example, a universal serial bus (USB) port, an Ethernet port, or some other port or interface, is provided to enable or facilitate electronic communication between the distribution device 116 and an external device (e.g., an external control system, a mobile device, a computing device) communicatively coupled to the external device. This electronic communication may occur via any known method, including, by way of example, USB, RS-232, RS-485, WiFi, Bluetooth, or any other suitable communication connection.

The logic 212 includes one or more routines and/or one or more sub-routines, embodied as computer-readable instructions stored on the memory 204. The distribution device 116, particularly the processor 200, may execute the logic 212 to cause the processor 200 to perform actions related to the distribution of electric power from the driver 108 to the light-producing sub systems 112. The logic 212 may, when executed, cause the processor 200 to receive and/or obtain signals or requests from the external device, determine the contents of any received and/or obtained signals or requests, access distribution settings stored in the memory 204, update the distribution settings stored in the memory 204, distribute (i.e., send or forward) electrical power to the light-producing sub systems 112 pursuant to the distribution settings, and/or perform other desired functionality. Logic functionality sufficient for the logic 112 may be found many of the control systems that are currently commercially available, and is typically referred to as scene control. Scene control is incorporated in many well known lighting control systems.

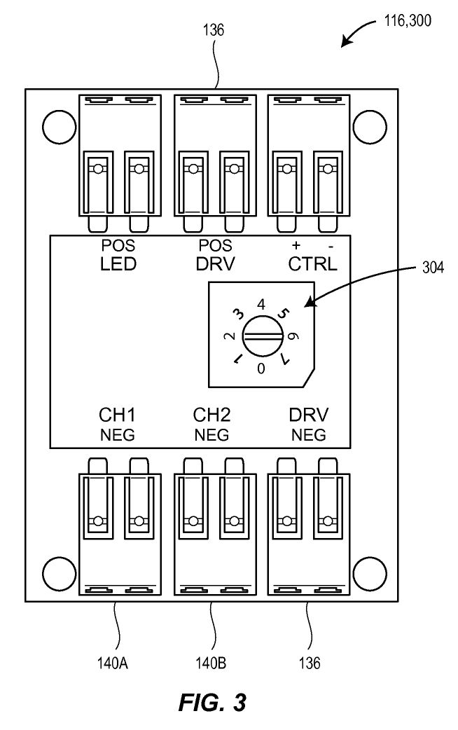

As illustrated in FIG. 3, the distribution device 116 can alternatively take the form of an on-board switching device 300 that facilitates control of the light-producing sub systems 112. The switching device 300 generally includes a plurality of pre-programmed or pre-selected distribution settings and a switch 304 that facilitates selection of one of the pre-programmed or pre-selected distribution settings. In this example, the switching device 300 includes eight different pre-programmed settings that correspond to eight different distribution ratios, e.g., 90/10, 80/20, 70/30, 60/40, 50/50, 40/60, 30/70, 20/80, for distributing electrical power to or between the light-producing sub systems 112. The switch 304 thus enables selection of a desired pre-programmed distribution ratio. For example, the switch 304 can be manipulated such that the pre-programmed distribution ratio 90/10 is selected. In any event, the distribution device 116 distributes, via the output ports 140A, 140B, electrical power based on the selected pre-programmed distribution ratio. When the pre-programmed distribution ratio 90/10 is selected, the distribution device 116 distributes, via the ports 140A, 140B, 90% of the electrical power provided by the driver 108 to one of the light-producing sub systems 112 and the remaining 10% of the electrical power to the other of the light-producing sub systems 112. Of course, if desired, the switch 304 can be manipulated to alter the selected pre-programmed distribution ratio.

While the switching device 300 includes eight settings that correspond to pre-programmed distribution ratios, the switching device 300 can, in other examples, include more or less settings corresponding to pre-programmed distribution ratios. Moreover, the pre-programmed settings of the switching device 300 can correspond to different settings, such as, for example, discrete values (e.g., 10V). Further customization can also be made possible by including more than one switching device 300 in the luminaire 100.

It will also be appreciated that the distribution device 116 can be implemented in other ways as well. As an example, the distribution device 116 can take the form of or include an on-board controller that includes a processor, a memory, a communications interface, and logic.

Based on the foregoing description, it should be appreciated that the luminaire described herein includes a single-channel driver, two or more light-producing sub systems, and a distribution device for distributing electrical power provided by the single-channel driver to the light-producing sub systems. Such an arrangement advantageously facilitates independent control of the two or more light-producing sub systems, thereby allowing for the luminaire to be controlled to yield a desired output of light (e.g., light having desired characteristics). At the same time, by utilizing a single-channel driver to power the light-producing sub systems instead of multi-channel drivers or different drivers for each light-producing sub system, as is conventionally done, the luminaire described herein is more cost-effective and energy-efficient than conventional luminaires. Moreover, single-channel drivers are, for energy-compliance purposes, rated more favorably than multi-channel drivers. As an example, the single-channel driver described herein is capable of providing each of the light-producing sub systems with a maximum of 40 Watts of electrical power (just not at the same time), yet will only be rated as a 40 Watt driver (as opposed to a conventional multi-channel driver, which would be rated as an 80 Watt driver). In such an example, the single-channel driver described herein would comply with an energy code such as California's (e.g., Title 24), while the conventional multi-channel driver would not.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. A luminaire, comprising:
a housing;
a first light-producing sub system disposed within the housing;
a second light-producing sub system disposed within the housing;
a single-channel driver disposed within the housing and configured to electrically power each of the first and second light-producing sub systems; and
a distribution device electrically connected to the single-channel driver, the distribution device configured to receive electrical power from the single-channel driver and distribute the electrical power to the first and second light-producing sub systems responsive to controllable distribution settings.

2. The luminaire of claim 1, wherein the distribution device is configured to control the distribution settings responsive to a control signal received by the distribution device.

3. The luminaire of claim 2, wherein the control signal comprises a 0-10 V control signal, a DALI control signal, or a DMX control signal.

4. The luminaire of claim 2, wherein the control signal comprises a distribution ratio indicative of the electrical power to be distributed to the first light-producing sub system and the second light-producing sub system.

5. The luminaire of claim 1, wherein the distribution device comprises a selector switch configured to facilitate control of the distribution settings.

6. The luminaire of claim 5, wherein the selector switch includes a plurality of pre-programmed settings.

7. The luminaire of claim 6, wherein the plurality of pre-programmed settings correspond to a plurality of different distribution ratios.

8. The luminaire of claim 1, wherein the first light-producing sub system comprises a first light-emitting diode board having one or more light-emitting diodes, the second light-producing sub system comprises a second light-emitting diode board having one or more light-emitting diodes, and the single-channel driver comprises a single-channel light-emitting diode driver.

9. The luminaire of claim 8, wherein the one or more light-emitting diodes of the first light-emitting diode board are configured to emit light having a first color, and wherein the one or more light-emitting diodes of the second light-emitting diode board are configured to emit light having a second color different from the first color.

10. The luminaire of claim 8, wherein the one or more light-emitting diodes of the first light-emitting diode board are configured to emit light having a first color temperature, and wherein the one or more light-emitting diodes of the second light-emitting diode board are configured to emit light having a second color temperature different from the first color.

11. The luminaire of claim 1, wherein the first light-producing sub system is configured to emit light in a first direction, and wherein the second light-producing sub system is configured to emit light in a second direction different from the first direction.

12. The luminaire of claim 11, wherein the first direction comprises a top of the housing.

13. The luminaire of claim 11, wherein the second direction comprises a bottom of the housing.

14. The luminaire of claim 11, wherein one of the first and second directions comprises a side of the housing.

15. The luminaire of claim 1, wherein the first light-producing sub system is configured to emit light having a first efficiency, and wherein the second light-producing sub system is configured to emit light having a second efficiency different than the first efficiency.

16. A method of providing a desired output of light from a luminaire, the method comprising:
supplying electrical power from a single-channel driver to a distribution device, the single-channel driver configured to electrically power a first light-producing sub system and a second light-producing sub system each disposed within a housing of the luminaire; and
distributing, via the distribution device, the electrical power from the single-channel driver to the first and second light-producing sub systems based on controllable distribution settings.

17. The method of claim 16, further comprising:
receiving, at the distribution device, a control signal; and
controlling the distribution settings based on the received control signal.

18. The method of claim 16, further comprising controlling the distribution settings via a selector switch.

19. The method of claim 16, wherein distributing the electrical power comprises distributing the electrical power from a single-channel light-emitting diode driver to the first and second light-producing sub systems.

20. The method of claim 16, further comprising emitting light having a first color from the first light-producing sub system and emitting light having a second color from the second light-producing sub system, the second color being different from the first color.

21. The method of claim 16, further comprising emitting light in a first direction from the first light-producing sub system and emitting light in a second direction from the second light-producing sub system, the second direction being different from the first direction.

22. The method of claim 16, further comprising emitting light having a first efficiency from the first light-producing sub system and emitting light having a second efficiency from the second light-producing sub system, the second efficiency being different from the first efficiency.
